(19) United States
(12) Patent Application Publication
(10) Pub. No.: US 2016/0121653 A1
(43) Pub. Date: May 5, 2016

(54) Traction Aid Device

(71) Applicant: Jasmin Letarte, Low (CA)

(72) Inventor: Jasmin Letarte, Low (CA)

(21) Appl. No.: 14/926,672

(22) Filed: Oct. 29, 2015

Related U.S. Application Data
(60) Provisional application No. 62/073,943, filed on Oct. 31, 2014.

(51) Int. Cl. B60B 39/00

(52) U.S. Cl. CPC B60B 39/00

(57) ABSTRACT

A reinforced traction aid device is provided for use with heavy transport and utility vehicles (HTUVs). The device comprises a U-shaped frame and a plurality of cross bars joining the side bars of the frame. This configuration provides structural support and traction means for a tire of a HTUV to engage and climb over the device when in use. Traction cleats engage the ground surface and stabilize the traction aid device, and two converging claws supported by a claw brace form the open end of the U-shaped frame to engage the tire tread cavities of the tire. A brace system is integrated into the device, comprising at least one linear and one or more additional linear and/or V-braces disposed in between the end bar of the U-shaped frame and cross bars to reinforce and help maintain the structural alignment of the traction aid device after repeated use.

### CROSS REFERENCE TO RELATED APPLICATION

This application claims priority to U.S. Provisional Application No. 62/073,943, filed on Oct. 31, 2014, which is incorporated by reference.

### FIELD OF THE INVENTION

The present invention relates to the field of traction aid devices for vehicles and more particularly, to a traction aid device adapted for use by heavy transport and utility vehicles stuck in ice and snow or otherwise immobilized by slippery ground surface conditions.

### BACKGROUND OF THE INVENTION

The use of traction aids for vehicles stuck in ice, snow and soft soils is known in the art. Such devices may include a rectangular frame, or U-shaped frame with tongues extending from the open end of the frame to engage the tire treads of the vehicle. Cross bars between the long, side members of a U-shaped frame help maintain the structural integrity of the frame and provide traction support to the wheel of the vehicle as it moves over the traction device. Another standard feature of such devices are a series of spikes or cleats positioned along, and extending below, the side members of the frame to engage with the ground surface under and proximal to the tire of a vehicle. The spikes or cleats anchor the device and allow the wheel to gain traction over the device to a surface from which the vehicle can continue to drive. Traction aids of this configuration may be used in front of the tire when the vehicle is in forward acceleration mode and at the rear of the tire when the vehicle is in rearward acceleration mode.

For example, U.S. Pat. No. 3,878,988 discloses a traction aid device that has traction members, for providing traction, extending between two side members, and gripping members, namely spikes, extending from the side members gripping the ground. The spikes are positioned along the side members substantially at the junction points where the traction members meet the side members. The traction aid device is also provided with claws (or tongues) extending from the side members of the U-shaped frame, configured to engage the tread cavities of a tire by a lever action on the traction aid device, in order to create positive initial traction with the wheel. The overall width of the traction aid device is less at the converging, open ends of the claws than at the closed end of the U-shaped frame and is at most about equal to the width of the tire tread.

Canadian Patent No. 1018203 discloses a U-shaped vehicular traction device wherein one or more of the cross bars extend above the plane of the top surface of the frame's side members (side rails). At least one of the cross bars also extends below the bottom surface of the side members. The placement of a pair of cleats opposite one another along the side members is coincident with the junction point where the ends of a cross bar and the side members meet. There is also a primary cross bar connecting the side members proximal to the open end of the U-shaped frame. The claws extending from the open end of the U-shaped frame are configured with claw ends extending in a downward direction to grip the ground surface, rather than the tires of the vehicle. Accordingly, it is the primary cross bar proximal to the claw ends which provides the initial traction (tire gripping) surface for the tire of the vehicle.

U.S. Pat. No. 5,100,054 discloses a rectangular vehicle traction assist device that is about two feet long and is adapted to be placed at a drive wheel of the vehicle. The device is preferably stamped from a flat plate of 11 gage cold rolled steel. Apertures are punched out to provide three cross bars that are given a 90 degree twist at each end to provide a central blade portion that engages both the tire tread and the underlying surface. The placement of a pair of (traction) cleats opposite one another along the side members is coincident with the junction points where the ends of a cross bar and the side members.

U.S. Pat. No. 7,404,524 discloses a folding U-shaped traction aid device with a cross bar joining the claws extending from the side members at the open end of the frame and series of pairs of traction cleats positioned along the side members in-between cross bars such that when the device is folded the cleats of one section nest inside the frame portion of the second section and the cleats of the second section rest on the outside of the frame portion of the first section.

Another traction device is disclosed in U.S. Pat. No. 6,129,289. The device is arranged to be laid on the ground in engagement with a tread portion of a tire to provide a traction grip to the tire. The traction device includes a U-shaped frame and a pair of claws constructed at the open ends of the U-shaped frame and arranged to engage into cavities between the tire treads by a lever action on the traction device. The traction device further includes a plurality of transverse braces extending between a pair of longitudinal bars of the U-shaped frame, each transverse brace having a pair of traction cleats extending downwardly to engage with the ground and to elevate the traction device from the ground in some measure. One of the transverse braces is positioned at a region near a forward (closed) end of the U-shaped frame with a corresponding pair of traction cleats configured to maintain the device in a level attitude, prevent a lever action from being created, and prevent the U-shaped frame from tilting or projecting upwardly which may cause injury or property damage as the vehicle passes over the forward end of the device.

The traction aids known in the art have typically been designed for use with standard motor vehicles ranging from compact cars, family vans, 4-wheel drive ATVs and light trucks. Some devices have been advertized as being suitable for use with heavier duty vehicles, such as the Traction Aids® product adapted with a plate spanning the underside of three cross-bars of the device as advertized on the Traction Aid website (tractionaids.com).

Such devices, however, are not widely adopted by operators of commercial, heavy transport and utility vehicles. Such vehicles will typically include Class 3 and above vehicles (i.e. with loads over 10,000 lbs) with reference to the US Federal Department of Transportation's Gross Vehicle Weight Rating (GVWR) system.

Accordingly, there remains a need for traction aid devices which can support the particular needs of commercial, heavy transport and utility vehicles with loads of up to tens of thousands of pounds, which may become immobilized on road and/or off-road due to snow, ice or soft soil, like mud and sand.

### SUMMARY OF THE INVENTION

The present invention relates generally to traction aid devices (TADs) adapted for use with heavy transport and utility vehicles (HTUVs) in snow, ice and/or soft ground conditions. It is an object of the present disclosure to provide a reinforced TAD that resists distortion or breakage when in use, due to the weight of HTUVs. The reinforcement of the TAD is provided in part by a brace system comprising one or more linear braces and/or V-braces disposed between the transverse bars joining the side bars of a U-shaped frame.

According to one aspect, there is provided a traction aid device comprising: a U-shaped frame and cross bar system comprising: a pair of longitudinally extending side bars with first and second ends, disposed substantially parallel to one another; a plurality of transverse bars disposed between the side bars, including: an end bar joining the first ends of the side bars; and three or more cross bars joining the side bars at different points along the length of the side bars, wherein one or more of the three or more cross-bars extends vertically above the top sides of the side bars; a pair of claws (tongues) converging as extensions of the side bars beyond the transverse bar positioned most distally from the end bar, including claw ends defining the second ends of the side bars and adapted to grip a tire tread; two or more traction cleats distributed along each side bar and extending vertically below the bottom sides of the side bars, configured to engage a ground surface; a claw brace joining the pair of claws; and a brace system comprising: one or more braces disposed between the plurality of transverse bars to join pairs of transverse bars, wherein one or more of said one or more braces is a linear brace disposed in a substantially perpendicular orientation relative to the pair of transverse bars it joins.

According to another aspect there is a provided a traction aid device comprising: a U-shaped frame and cross bar system comprising: a pair of longitudinally extending side bars with first and second ends, disposed substantially parallel to one another; a plurality of transverse bars disposed between the side bars, including: an end bar joining the first ends of the side bars; and three or more cross bars joining the side bars at different points along the length of the side bars, wherein one or more of the three or more cross-bars extends vertically above the top sides of the side bars; a pair of claws (tongues) converging as extensions of the side bars beyond the transverse bar positioned most distally from the end bar, including claw ends defining the second ends of the side bars and adapted to grip a tire tread; two or more traction cleats distributed along each side bar and extending vertically below the bottom sides of the side bars configured to engage a ground surface; a claw brace joining the pair of claws; and a brace system comprising: one or more linear braces, each disposed between and joining a pair of transverse bars, in a substantially perpendicular orientation to said transverse bars; and one or more V-braces, each including first and second brace members disposed between and joining a pair of transverse bars.

In various embodiments of the traction aid device, one or more of the three or more cross bars is positioned so that their bottom ends are flush with the bottom ends of the side bars.

In another embodiment of the traction aid device, the side bars and transverse bars are made of ¼ inch thick metal strips.

In still a further embodiment the traction aid device is protected from corrosion by way of a powder coating process.

In yet another aspect, there is provided a method of using a traction aid device to provide traction aid to a tire of a heavy transport and utility vehicle (HTUV), wherein the traction aid device comprises: a U-shaped frame including side bars and an end bar defining the closed end of the frame; cross bars disposed along the length of and in between the side bars, configured to provide traction aid to a tire of a HTUV; two claws with claw ends defining the open end of the U-shaped frame and configured to grip the tread cavities of the tire; traction cleats disposed along the side bars configured to engage a ground surface under and proximal to the tire; a claw brace joining the claws; and a plurality of braces disposed in between the end bar of the frame and cross bars to join pairs of bars transverse to the side bars and reinforce the structural integrity and alignment of the traction aid device, wherein the steps of the method comprise: inserting the claws of the traction aid device at an angle in between the tire and the ground surface immediately under and proximal to the tire; engaging the claw ends in the tread cavities of the tire; putting the HTUV in an acceleration mode; and driving the HTUV over the traction aid device.

In an embodiment, the use of the traction aid device is for HTUVs with loads of about 10,000 lbs or more.

### BRIEF DESCRIPTION OF THE DRAWINGS

These and other features of the invention will become more apparent in the following detailed description in which reference is made to the appended drawings.

FIG. 1A: is a top and side perspective view of a TAD in accordance with an exemplary embodiment of the invention indicating various features of the U-shaped frame and cross bar system, as well as the bracing system of the TADs disclosed herein.

FIG. 1B: is a top and side perspective view of a TAD in accordance with an exemplary embodiment of the invention indicating various top, bottom and vertical sides (faces) of the side bars, end bar, cross bars, (linear and V) braces, claw brace and claw ends of the TADs disclosed herein.

FIG. 1C: is a top and side perspective view of a TAD illustrating an alternative off-set configuration of the traction cleats.

FIG. 2: is a side elevation view of the TAD shown in FIGS. 1A and 1B depicting an exemplary off-set configuration (placement) of traction cleats on opposing side bars to facilitate TAD stacking.

FIG. 3: is a top view of the bracing system used to reinforce the U-shaped frame and cross bar system of the TAD, also shown in FIGS. 1A and 1B.

FIG. 4: is a schematic representation of the power divider action of a HTUV (double-axle).

FIGS. 5a-5f: are schematic representations of various exemplary bracing system configurations of the TADs disclosed herein.

### DETAILED DESCRIPTION OF THE INVENTION

The present disclosure relates to reinforced TADs constructed for repeated use with HTUVs. The design of the TADs according to the disclosure comprises a U-shaped frame and cross bar system for providing primary traction aid to a HTUV and reinforcement means comprising a brace system of linear braces and V-braces to help maintain the structural integrity and alignment of the U-shaped frame and cross bar system.

Additional embodiments of the TADs disclosed herein provide for the safe and effective use of the TADs by operators of HTUVs, including various stacking and packaging options.

### DEFINITIONS

Unless defined otherwise, all technical and scientific terms used herein have the same meaning as commonly understood by one of ordinary skill in the art to which this invention belongs.

The use of the word “a” or “an” when used herein in conjunction with the term “comprising” may mean “one,” but it is also consistent with the meaning of “one or more,” “at least one” and “one or more than one.”

As used herein, the terms “comprising,” “having,” “including” and “containing,” and grammatical variations thereof, are inclusive or open-ended and do not exclude additional, unrecited elements and/or method steps. The term “consisting essentially of” when used herein in connection with an apparatus, system, use or method, denotes that additional elements and/or method steps may be present, but that these additions do not materially affect the manner in which the recited apparatus, system, method or use functions. The term “consisting of” when used herein in connection with an apparatus, system, use or method, excludes the presence of additional elements and/or method steps. An apparatus, system, use or method described herein as comprising certain elements and/or steps may also, in certain embodiments consist essentially of those elements and/or steps, and in other embodiments consist of those elements and/or steps, whether or not these embodiments are specifically referred to.

As used herein, the term “about” refers to an approximately +/−10% variation from a given value. It is to be understood that such a variation is always included in any given value provided herein, whether or not it is specifically referred to.

As used herein, the term “heavy transport and utility vehicle” or abbreviation “HTUV” in singular and plural forms, includes any commercial or public motor vehicle(s) weighing over about 4500 kg. Exemplary HTUVs include those used to transport heavy loads or cargo on highways (tractor trailers), or other vehicles used in construction, industrial operations, for municipal utility purposes (fuel and refuse), consumer goods delivery, passenger transport and other commercial or public activities, both on-road and/or off-road.

As used herein, the term “ground surface” may denote snow and/or ice covered surfaces, on or off road, as well as other slippery ground surface conditions, such as soft soil conditions (e.g. mud, sand) that may come into contact with the driving surface of a HTUV tire and prevent it from having sufficient traction to move forward or backward when in an acceleration mode. A “ground surface” may also denote any combination of snow, ice and/or soft soil that impedes a HTUV from moving, or that renders it in an immobile state unable to gain traction to be able to freely move in a forward or rearward direction.

The terms “engagement”, “engage” (or any conjugation of the verb), when used in reference to a traction cleat, or any part of the underside of the TADs, means a degree of contact or penetration of the TAD with or into the ground surface sufficient to create a resistance force that allows the TAD to remain stable without being projected out from underneath the tire, as a result of the forward or backward movement of the HTUV over the TAD. Engagement of a ground surface by a TAD may result in various degrees of ground surface contact and/or penetration. In some cases the engagement with a ground surface may result in a traction cleat partially penetrating a ground surface and in other cases it may result in the undersides of one or more of the U-shaped frame, cross bars and/or linear and V-brace of the TAD penetrating the ground surface. Otherwise, when the terms “engagement”, “engage” (or any conjugation of the verb) are used with reference to the top surfaces of the U-shaped frame, cross bars, claw brace, or claws and claw ends, it means a form of frictional contact sufficient for a tire to gain traction, without the tire rubber being punctured or torn.

It is contemplated that any embodiment discussed herein can be implemented with respect to any disclosed method, use, apparatus or system, and vice versa. Furthermore, an apparatus and/or system of the invention can be used to achieve the disclosed methods and uses.

It is understood that reference to various embodiments of the TADs of the present disclosure and uses thereof, including those depicted in the Figures are illustrative of certain embodiments of the TADs and are not intended to limit the scope of the invention in any way.

### TAD Structure

The TADs disclosed herein comprise a U-shaped frame and cross bar system for engaging with a tire, supporting the tire and providing traction aid to the tire of a HTUV. This system includes a U-shaped frame, cross bars, claws, and traction cleats. The traction cleats engage the ground surface under and proximal to the tire to be provided with traction aid as it climbs and passes over the TAD. In this way, the TAD of the present disclosure is configured to facilitate a HTUV to move from an immobile state in a forward or rearward direction when in an acceleration mode, so as to become freely mobile again.

### U-Shaped Frame and Cross Bar System

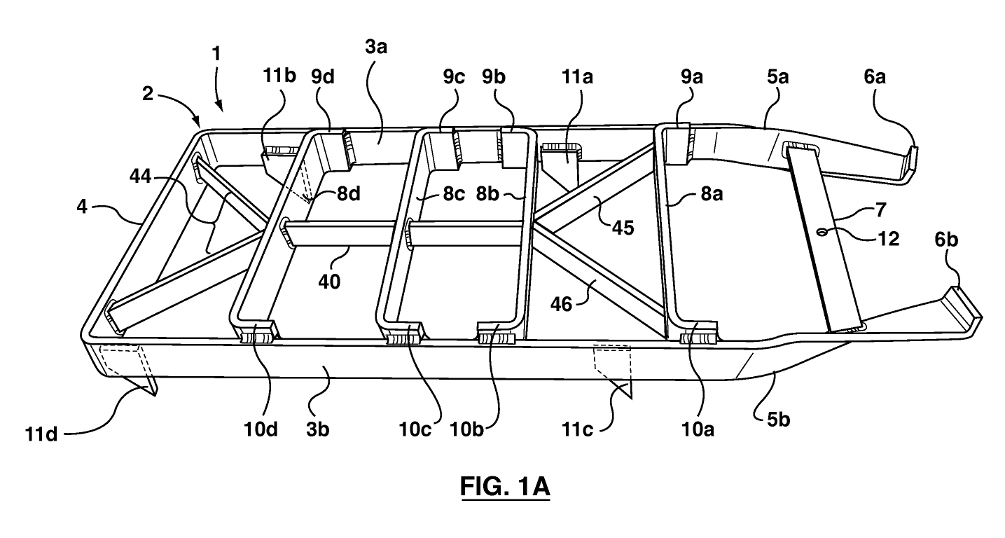

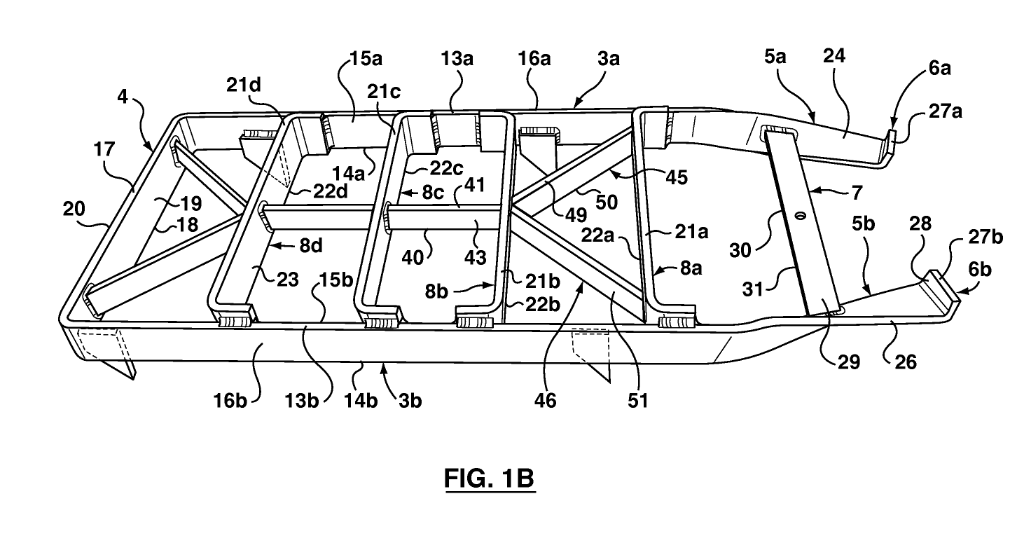

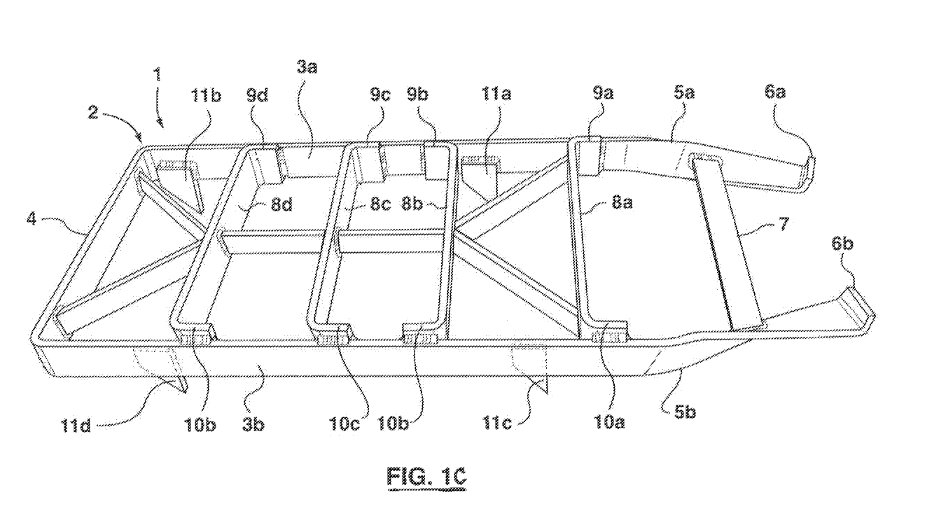

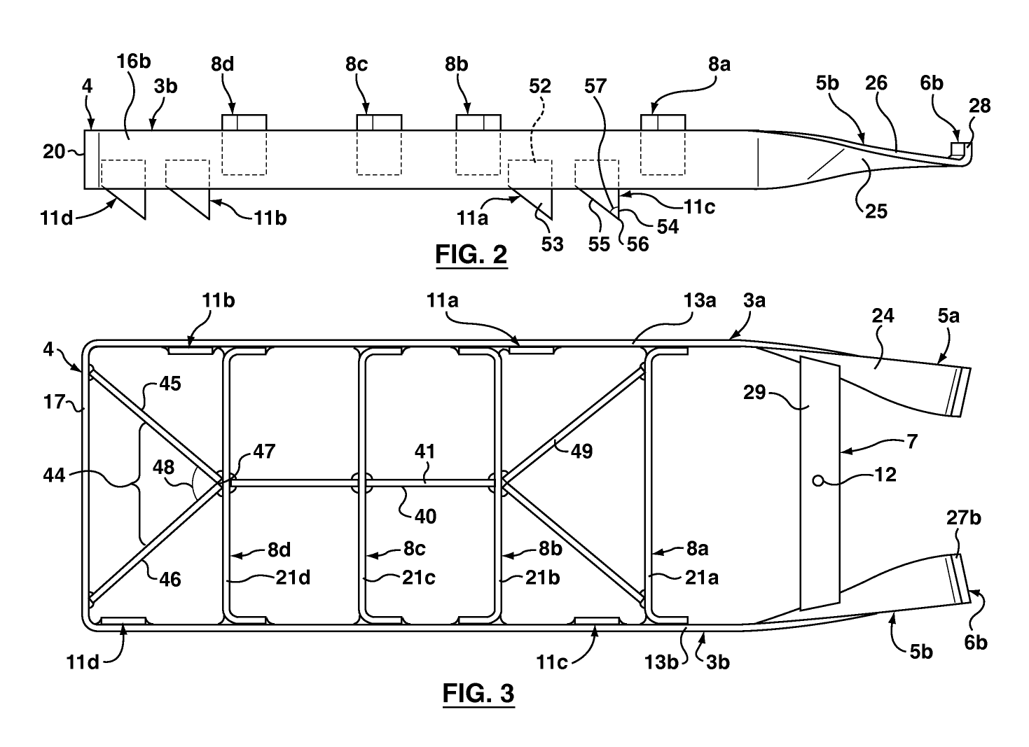

The U-shaped frame and cross bar system comprises: a U-shaped frame, cross-bars, claws and traction cleats which together provide primary traction aid to a tire of a HTUV. The features of this system are described in greater detail below with reference to FIGS. 1A, 1B and 2.

### U-Shaped Frame

In one illustrative embodiment shown in FIGS. 1A, 1B and 2, the TAD 1 comprises a U-shaped frame 2, including two side bars 3a, 3b extending longitudinally and disposed substantially parallel to each other, joined by a transverse end bar 4 at one set of (first) ends of the side bars 3a, 3b.

In one variation of the U-shaped frame 2 shown in FIGS. 1A, 1B and 2, the side bars 3a, 3b are spaced 8 inches apart from one another.

In another embodiment, the U-shaped frame 2 has a squared-off closed end defined by the linear end bar 4 joining the first ends of the side bars 3a, 3b. In an alternative embodiment, that U-shaped frame has a curved closed end.

In still another variation of the TAD 1 illustrated in FIGS. 1A, 1B and 2, the vertically-oriented inner and outer side faces 19, 20 of the end bar 4 and side bars 15a, 15b, 16a, 16b, respectively, are about 1 inch high and the top and bottom sides of the end bar 17, 18 and side bars 13a, 13b, 14a, 14b are about ¼ inch wide.

### Cross Bars

The side bars 3a, 3b are joined by a plurality of cross bars 8a-8d disposed in between and in a substantially perpendicular orientation relative to the side bars 3a, 3b. Each vertically oriented side face 23 of the cross bars 8a-8d is about 1¼ inch high. The top and bottom sides 21a-21d, 22a-22d of the cross bars 8a-8d are about ¼ inch wide.

The cross bars 8a-8d are attached to the side bars 3a, 3b by bending the cross bars 8a-8d about 90°, ½ inch from the ends and welding the bent cross bar ends 9a-9d, 10a-10d to the inner side faces 15a, 15b of the side bars 3a, 3b of the U-shaped frame (2). In this case, the cross bar ends 9a-9d, 10a-10d will end up being about ⅝ of inch long (wide).

In a variation of the embodiment shown in FIGS. 1A, 1B and 2, the cross bar ends 9a-9d, 10a-10d are fully welded all around (rather than spot welded) to the inner side faces 15a, 15b of the side bars 3a, 3b. In another variation, the cross bar ends 9a-9d, 10a-10d are welded on three sides (i.e. not along the bottom side of the cross bar ends). Welding around the sides of the cross bar ends 9a-9d, 10a-10d helps to ensure a solid and durable construction, thereby minimizing the chances that the cross bars 8a-8d will break away from the U-shaped frame 2 under the weight of the HTUV during use of the TAD 1.

In yet another embodiment as shown in FIGS. 1A, 1B and 2, the cross bar ends 9b and 9c, and 10b and 10c are bent towards each other. This provides maximum space for the placement of traction cleats 11a and 11c at different positions along the side bars 3a and 3b (respectively) between cross bars 8a and 8b.

The cross bars 8a-8d as shown in FIGS. 1A, 1B and 2 are disposed between and along the length of the side bars 3a, 3b to provide distributed structural support and traction for the tire of a HTUV when the TAD 1 is in use. In one embodiment, the top sides 21a-21d of the cross bars 8a-8d extend vertically ¼ inch above the top sides 13a, 13b of the side bars 3a, 3b. In another embodiment, the bottom sides of the cross bars 22a-22d are at least flush with the bottom sides 14a, 14b of the side bars to enhance the engagement of the TAD 1 with a ground surface when in use.

In an alternative embodiment the cross bars 8a-8d may be disposed between the side bars 3a, 3b such that the top sides 21a-21d of the cross bars 8a-8d are above the top sides 13a, 13b of the side bars 3a, 3b, and the bottom sides 22a-22d of the cross bars 8a-8d are below the bottom sides 14a, 14b of the side bars 3a, 3b.

In still another embodiment, the top sides 21a-21d of the cross bars 8a-8d may be notched (not shown) in order to enhance the traction effect when the tire of a HTUV drives over the TAD 1.

Different transverse bar spacing arrangements may be used in order to accommodate other structural features of the TAD 1, such as the off-set placement of the traction cleats 11a-11d to facilitate the stacking of TADs when not in use. In one embodiment the spacing between transverse bars 4, 8a-8d is between about 2 to about 5 inches apart. In another embodiment the spacing between transverse bars 4, 8a-8d is between about 2½ to about 4 inches apart. In still another embodiment the spacing between transverse bars 4, 8a-8d is about 2¾ to about 3¼ inches apart.

In a variation of the exemplary embodiment of the TAD 1 shown in FIGS. 1A, 1B and 2, the spacing between transverse bars 4, 8a-8d is substantially equidistant, for example, about 3 inches between cross bars 8a and 8b, about 2¾ inches between cross bars 8b and 8c, about 2¾ inches between cross bars 8c and 8d, and about 3 inches between cross bar 8d and the end bar (4).

The spacing of the cross bars 8a-8d may be varied and not all of the cross bars 8a-8d need be in a substantially equidistant arrangement relative to each other, so long as a substantially distributed traction means is provided for the tire passing over the TAD 1 when in use. In another embodiment, a pattern of alternating shorter and longer transverse bar 4, 8a-8d spacing may be provided. For example, the distance between cross bars 8a and 8b may be about 4 inches, between cross bars 8b and 8c about 2 inches, between cross bars 8c and 8d about 4 inches and between cross bars 8d and the end bar 4 about 2 inches. Alternatively, the spacing between cross bar 8a and 8b may be about 4 inches, between cross bars 8b and 8c about 2 inches, between cross bars 8c and 8d about 2 inches and between cross bar 8d and the end bar 4 about 4 inches.

In one embodiment, the four cross bars 8a-8d are distributed along about 13½ inches of the side bars' 3a, 3b length, as measured from the first ends of the side bars 3a, 3b to the point just before the formation of the claws 5a, 5b.

In alternative embodiments, three cross bars 8a-8d are used for TADs ranging from about 16 to about 20 inches in total length, as measured from the outer vertical side surface 20 of the end bar 4 to the second ends of the side bars 3a, 3b defined by the claw ends 6a, 6b. In still other embodiments, four cross bars are used for TADs ranging from about 18 inches to about 24 inches in total length, as measured from the outer vertical side surface 20 of the end bar 4 to the second ends of the side bars 3a, 3b defined by the claw ends 6a, 6b. In each of these embodiments, the claws 5a, 5b are about 5¼ inches from the point where the side bars start to bend and twist to form the claws 5a, 5b to the outer vertical face of the claw ends 6a, 6b, as further described below.

### Claws (Tongues)

With reference to FIGS. 1A, 1B and 2, the portion of the side bars 3a, 3b extending away from the end bar 4 and beyond cross bar 8a, are bent and twisted to converge and thereby define two claws (tongues) 5a, 5b. The formation of the claws 5a, 5b results in the previously vertically oriented sides 15a, 15b, 16a, 16b of the side bars 3a, 3b taking on a horizontal orientation, such that each claw has a about a one inch wide top side portion 24 and one inch wide bottom side portion 25 proximal to the claw ends 6a, 6b.

In a variation of the embodiment shown in FIGS. 1A, 1B and 2, the claws 5a, 5b are at least about 5¼ inches from the point that the side bars 3a, 3b begin to twist to the claw ends 6a, 6b, thereby defining the second ends of the side bars 3a, 3b. In this configuration, working in accordance with the properties of A36 steel, the twisted portion of the claws 5a, 5b may be about 1½ to about 2 inches long. In yet another embodiment the claws 5a, 5b may be longer than 5¼ inches, so long as the claws are sufficiently reinforced by one or more claw braces 7 as further described below.

Additionally, in the embodiment illustrated in FIGS. 1A, 1B and 2, the claw ends 6a, 6b are the free ends of the claws 5a, 5b bent upward at about a 90° angle relative to the horizontally oriented top and bottom side portions 24, 25 of each claw 5a, 5b. In a variation of this embodiment, each claw end 6a, 6b is about % of an inch high. With this configuration, the claw ends 6a, 6b can engage a tire's tread cavities so that the tire can grip the TAD 1 and start climbing over it in a forward or rearward direction when in use. In alternative embodiments the claw ends 6a, 6b are about ¼ of an inch to about 1 inch high.

In another variation of the embodiment shown in FIGS. 1A, 1B and 2, the distance between the two claw ends 6a, 6b is about 6 inches. This distance maps to the typical width of the deep tread cavities of a tire, of the type used on tractor trailers and other HTUVs. One skilled in the art would understand that the distance between the claw ends 6a, 6b may be adapted to match the width of the treads of any tire to facilitate adequate gripping engagement with the TAD 1. One skilled in the art would also appreciate that care must be taken not to have the claw ends 6a, 6b engage the tire too close to its outer edges. At the outer edges, the tire rubber tends to be thinner and more prone to tearing and puncturing compared to the driving surface of the tire where the deep tread cavities are found.

### Traction Cleats

As shown in the embodiment of FIGS. 1A, 1B and 2, the TAD 1 comprises four traction cleats 11a-11d, two disposed along each side bar (3a, 3b). The cleats 11a-11d function as ice, snow, or ground picks to engage the ground surface beneath and proximal to the tire of a HTUV when the TAD 1 is in use. In alternative embodiments, the traction cleats may be disposed either along the inner or outer vertical faces 15a, 15b, 16a, 16b, respectively, of the side bars 3a, 3b.

In a variation of the embodiment of FIGS. 1A, 1B and 2, each traction cleat 11a-11d is about 1% of an inch high and ¼ of an inch thick and disposed on the inner vertical faces 15a, 15b of the side bars 3a, 3b. A first portion 52 of each cleat 11a-11d is attached to a side bar 3a, 3b and is about ¾ of inch wide. In another embodiment the first portion 52 of each traction cleat 11a-11d is about 1 inch wide.

A second portion 53 of each cleat 11a-11d extends below a side bar 3a, 3b and includes a vertical edge 54 oriented perpendicular to the side bar 3a, 3b and an angled edge 55 extending downward to converge at a 45° angle 57 with the vertical edge 54, and form a cleat point 56. In an alternative embodiment, the angle 57 formed at the cleat point 56 is 40°.

In another embodiment the length (height) of the second portion 53 of each of the traction cleats 11a-11d is equivalent to or less than the height of a side bar's 3a, 3b vertically oriented side faces 15a, 15b, 16a, 16b. This allows TADs to be stacked in such a manner so that the traction cleats 11a-11d of one TAD can be safely nested within the inner side faces 15a, 15b of the side bars 3a, 3b of another TAD without protruding and risking injury to the user. In one embodiment, the portion 53 of each of the traction cleats 11a-11d extending below the bottom faces 14a, 14b of the side bars 3a, 3b is about ⅞ of an inch high. In another embodiment the portion 53 of each of the traction cleats 11a-11d extending below the bottom faces 14a, 14b of the side bars 3a, 3b is about ½ of an inch high. In yet another embodiment, the portion 53 of each of the traction cleats 11a-11d extending below the bottom faces 14a, 14b of the side bars 3a, 3b is about ¾ of an inch high.

In still another embodiment, the TAD comprises four or more traction cleats, attached to the vertically-oriented inner side faces 15a, 15b of the side bars 3a, 3b. The choice to include more than two traction cleats on a side bar will depend on a number of factors, including whether it is desirable to off-set the spacing of the cleats on opposite side bars for safety and storage purposes, as shown in FIGS. 1A, 1B and 2. In the illustrated embodiment, traction cleats 11a and 11b are disposed along side bar 3a proximal to cross bars 8d and 8b, respectively. By contrast, traction cleats 11c and 11d are disposed along side bar 3b proximal to cross bar 8a and the end bar 4.

In an alternative embodiment as shown in FIG. 1C, traction cleats 11a and 11b are disposed along side bar 3a proximal to cross bar 8b and the end bar 4, respectively, and cleats 11c and 11d are disposed along side bar 3b proximal to cross bars 8a and 8d, respectively.

### TAD Reinforcing Means

The TADs of the present disclosure are structurally reinforced so that the structural integrity and alignment of the U-shaped frame and cross bar system can be maintained after repeatedly being subjected to the weight of a HTUV. The principal reinforcement means are a claw brace to prevent the distortion (bending) of the claws and a plurality of braces (brace system) to maintain the alignment and structural integrity of the side bars and cross bars of the U-shaped frame and cross bar system.

### Claw Brace

With reference to FIGS. 1A, 1B and 2, a claw brace 7 joins claws 5a, 5b to prevent them from being bent or distorted by the weight of the HTUV when it passes (drives) over the TAD 1 in an acceleration mode. The horizontally oriented top and bottom sides 29, 30 of the claw brace 7 are about ¾ of an inch wide and each vertically oriented side 31 of the claw brace 7 is about 3/16 of an inch high.

In one embodiment as shown in FIGS. 1A, 1B and 2, the claw brace 7 is positioned sufficiently proximal to the claw ends 6a, 6b to maintain the structural orientation and integrity of the claws 5a, 5b. The claw brace 7 is positioned to be substantially parallel to cross bar 8a and attached so as to overlap in whole or in part with each top side portion 24 of the claws 5a, 5b.

In another embodiment, the claw brace 7 may be attached to overlap in whole or in part with each bottom side portion 25 of the claws 5a, 5b. It would be understood by one skilled in the art that when the claw brace 7 is positioned to or at the transition point between the twists in the claws 5a, 5b and the horizontally oriented side portions 24, 25 as the case may be, the ends of the claw brace 7 may need to be bent in order to be securely attached to the claws 5a, 5b.

The placement of the claw brace 7 may be adapted depending on the length and angle of convergence of the claws 5a, 5b in order to provide the optimal structural support. In a variation of the embodiment shown in FIGS. 1A, 1B and 2, the distance between the vertical side 31 of the claw brace 7 proximal to the claw ends 6a, 6b is about 2 inches. In yet another embodiment, the distance between the vertical side 31 of the claw brace 7 proximal to the claw ends 6a, 6b is about 1 inch. In a further embodiment the claw brace 7 may be welded such that the vertical side proximal to the claw ends 6a, 6b is substantially adjacent to said claw ends 6a, 6b.

In one embodiment of the TAD 1, as shown in FIGS. 1A, 1B and 2, a 3/16 inch diameter hole 12 is positioned at a substantially half way point along the length of the claw brace 7 to facilitate the handling of the TAD 1 when being, painted, coated or treated to provide a protective (anti-corrosion) finish on the surface of the TAD 1. In one embodiment the TAD 1 is painted using Tiger Series 39 polyester triglycidyl isocyanurate (TGIC) powder coating, in accordance with the manufacturer's guidelines.

### Bracing System

To reinforce the structural integrity and maintain the alignment of the TAD depicted in FIGS. 1A, 1B and 2, there are two linear braces 40 attached to cross bars 8d and 8c, and 8c and 8b, respectively. The linear braces 40 are in a substantially perpendicular orientation relative to the cross bars 8b-8d and disposed at a substantially half point between the side bars 3a, 3b. In a variation of the embodiment of the TAD 1 shown in FIGS. 1A, 1B and 2 each linear brace 40 has vertically oriented side faces 43 about ¾ of an inch high and top and bottom sides 41, 42 about 3/16 of an inch wide (thick).

The height and thickness of a linear brace 40 may be varied to be higher or thicker than what is described for the embodiment shown in FIGS. 1A, 1B and 2. In an alternative embodiment, the height and width of a linear brace 40 is the same as the height and width of the two transverse bars 4, 8a-8d it connects.

In another embodiment, a linear brace 40 is disposed such that neither the bottom side 42 nor the top side 41 of the linear brace 40 are flush with the bottom sides 18, 14b-14d or top sides 17, 13b-13d of the two transverse bars 4, 8b-8d it connects.

In an alternative embodiment, a linear brace 40 is disposed such that the top side 41 is flush with the top sides 17, 13b-13d of the two transverse bars 4, 8b-8d it connects. In still another embodiment, the bottom side 42 of a linear brace 40 is disposed to be flush with the bottom sides 18, 14b-14d of the two transverse bars 4, 8b-8d it connects. In yet another embodiment, a linear brace 40 is disposed to extend below the bottom sides 18, 14b-14d of the two transverse bars 4, 8b-8d it connects.

In the embodiment illustrated in FIGS. 1A, 1B and 2, there are between the end bar 4 and cross bar 8d and the cross bars 8a and 8b, two V-braces 44 which provide additional structural reinforcement to the TAD 1. Each V-brace 44 has two members 45, 46 with first diverging and second converging ends, which are disposed in between the transverse bars 4, 8d, 8a, 8b. The converging ends of the members 45, 46 join to form a V-point 47 with an acute angle 48 of about 90° along a central longitudinal axis between the side bars 3a, 3b. The V-point 47 is oriented towards a center point along said longitudinal axis between the side bars 3a, 3b. In variations of the embodiment shown in FIGS. 1A, 1B and 2, the acute angle 48 of the V-point 47 that is formed by the V-brace members 45, 46 may vary depending on the distance between the side bars 3a, 3b and the distance between transverse bars 4, 8d and 8a, 8b. The angle 48 may also vary depending on the placement of the diverging ends of the V-brace members 45, 46 along the length of the transverse bars 4, 8a.

In one embodiment, the V-brace 44 is constructed of one continues piece of metal strip bent at a 90° angle to form the V-point 47 and V-brace members 45, 46 of the V-brace 44. In another embodiment the V-brace members 45, 46 are two separate strips of metal that converge and are welded to form a V-point 47. In yet another embodiment the V-brace members 45, 46 need not converge to form a V-point, but will instead be welded to a transverse bar 4, 8a-8d in a converging orientation relative to one another.

In one embodiment, the diverging ends of the V-brace members 45, 46 are welded to a transverse bar proximal to (but not at) the joint points of the transverse bars 4, 8a-8d and side bars 3a, 3b. This helps to ensure that the full structural support function of the V-brace 44 is distributed between transverse bars 4, 8a-8d.

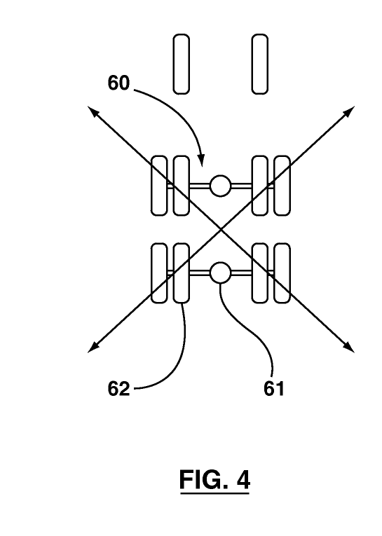

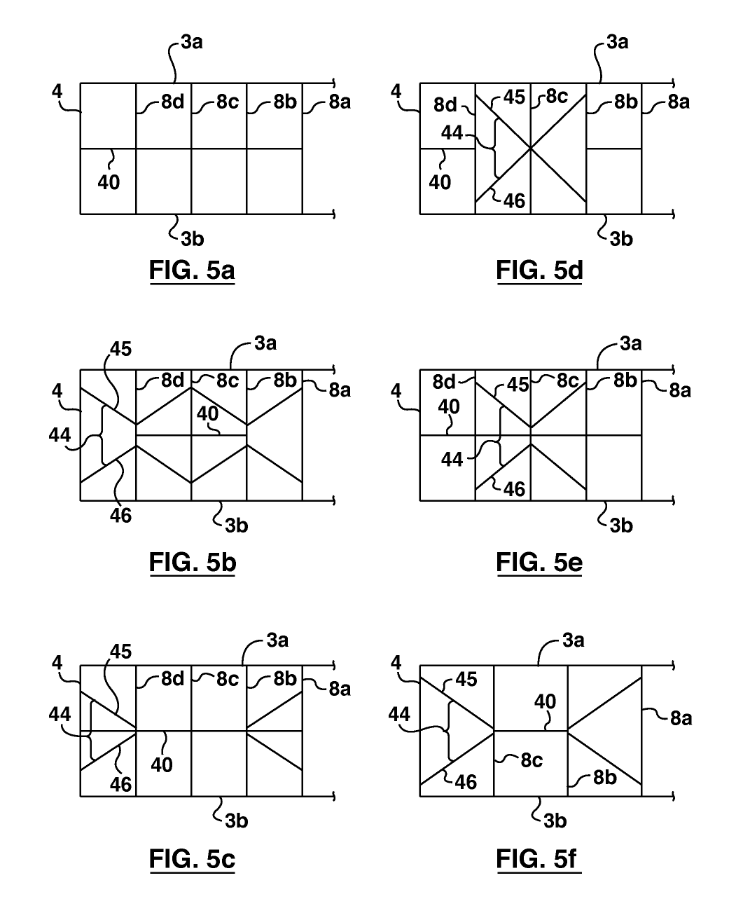

The bracing system of the TADs disclosed herein may comprise a series of linear braces 40, a series of V-braces 44, or a combination of linear braces and V-braces. For the TAD 1 to be durable and resist being bent out of shape by the weight of a HTUV passing over it, in one embodiment there is one or more braces joining all transverse bars 4, 8a-8d. Exemplary configurations of the TAD bracing system are illustrated in FIGS. 5a-5f.

### TAD Construction

The design and construction of the TADs disclosed herein allow the TADs to be used with a full range of HTUV weights and wheel-axle systems (e.g. single axle, double axles and combinations of single and double axles).

### HTUV Classification

HTUVs may be classified in accordance with regulations administered by government authorities responsible for transportation. For example, the US Department of Transportation uses a multi-class system under which most HTUVs (commercial vehicles) used for transport, construction and municipal utilities fall in Classes 3-8.

A Class 3 commercial vehicle (e.g. city delivery, standard walk-ins, and minibus vehicles) denotes a load range beginning at 10,001 lbs.

A Class 4 commercial vehicle (e.g. large walk-in, city delivery, moving van and landscape utility vehicles) denotes a load range beginning at 14,001 lbs.

A Class 5 commercial vehicle (e.g. bucket, city delivery and large walk-in vehicles) denotes a load range beginning at 16,001 lbs.

A Class 6 commercial vehicle (e.g. beverage, rack, school bus, single axle van and stake body vehicles) denotes a load range beginning at 19,501 lbs.

A Class 7 commercial vehicle (e.g. city transit bus, furniture delivery, high profile semi-tractor, home fuel, medium semi-tractor, refuse and towing vehicles) denotes a load range beginning at 26,001 lbs.

A Class 8 commercial vehicle (e.g. cement mixers, dump trucks, fire truck, tour buses, fuel trucks and tractor trailers) denotes a load range beginning at 33,001 lbs and over.

In one embodiment the TAD of the present disclosure is configured for use with Class 3-8 HTUVs.

In another embodiment the TAD of the present disclosure is configured for use with Class 4-8 HTUVs.

In still another embodiment the TAD of the present disclosure is configured for use with Class 5-8 HTUVs.

In a further embodiment the TAD of the present disclosure is configured for use with Class 6-8 HTUVs.

In yet a further embodiment the TAD of the present disclosure is configured for use with Class 7 and 8 HTUVs.

In an alternative embodiment the TAD of the present disclosure is configured for use with Class 8 HTUVs.

### TAD Materials and Dimensions

The TADs of the present disclosure are generally made of metals which have high tensile strength, such as steel. The choice of steel used, such as hot or cold pressed steel, is dictated by the consistency of the thickness of the metal strips used to construct the various features of the TADs such as those making up the U-shaped frame and cross bar system.

The thickness of the starting steel alloy material will end up defining, for example, the dimensions of the top and bottom sides of the side bars, end bar, cross bars, linear and V-braces, vertical sides of the claw brace and the thickness of the traction cleats as shown in FIGS. 1A, 1B and 2.

The various dimensions of the different parts of the TADs with reference to FIGS. 1-3, were determined on the basis of testing different constructions of preliminary TADs to arrive at the basic conceptual design for the TADs of the present disclosure.

It was found that using about ¼ inch thick steel to construct the features of the U-shaped frame and cross bar system provides the TADs described herein with sufficient strength and durability under repeated use to withstand the weights of load carrying tractor trailers which can routinely reach about 40,000 lbs (about 18,000 kg). Strips of ¼ inch steel have the added benefit of generally being sufficiently pliable and machinable to cut, bend, and weld using standard tools and methods well known to one skilled in the art.

It was also found that if the side bars, end bar and cross bars have a height of at least about 1 inch, this will also make the TADs of the present disclosure suitable for use with a full range of HTUV weights. One skilled in the art would appreciate, however, that these features of the TADs of the present disclosure could be constructed with alternative dimensions customized to the different weight classes of HTUVs.

The thickness of the steel metal strips cut to construct the various reinforcing braces of the TADs disclosed herein, can be less than ¼ inch thick in order to achieve the desired balance of structural integrity, durability and weight for carrying and use of the TADs by operators of HTUVs.

In one embodiment, the TAD of the present disclosure is constructed to weigh between about 7.0 to about 9.0 lbs. In another embodiment the TAD weighs 7.5 lbs. In still another embodiment the TAD weighs about 8.0 lbs. In yet another embodiment the TAD weighs about 8.5 lbs.

In another embodiment, the features of the U-shaped frame and cross bar system of the TADs are made of about ¼ inch thick metal strips. To help ensure durability and minimize breakage, the U-shaped frame (including the side bars and end bar) are constructed of one continuous strip of metal bent to create the desired U-shape. If the U-shaped frame is constructed of two or more separate pieces of metal strip welded together, the frame structure will be more prone to breaking under the weight of a HTUV when in use.

In still another embodiment the metal used to construct the TADs disclosed herein is hot-rolled steel (e.g. alloy A36). The uniformity of this steel's thickness can vary by about 1/16 of an inch, but is generally more affordably priced.

In a further embodiment, the metal used to construct the TADs is cold-rolled steel (e.g. alloy 1018) which is more uniform in thickness (i.e. varies less than hot-rolled steel), but is generally more expensive than hot-rolled steel to use as a starting material.

In yet another embodiment, the TAD is constructed of steel having about the same or more tensile strength as A36 steel. In other embodiments, the TAD is constructed of a steel alloy selected from the group of 1008, 1011, 1018, 1144, 12L14, and A366/1008.

### Size of the TADs

The TADs disclosed herein need to be long enough so that the treads of a tire of a HTUV can grip the TAD as the tire turns and pulls the HTUV out of its immobilized state. In one embodiment the TAD disclosed herein is at least about 16 inches long as measured from the outer vertical face of the frame's end bar to the end of the claws defined by the end claws.

In another embodiment the TADs are about 16 to about 24 inches long. In still another embodiment the TADs are about 16 to about 20 inches long and in yet another embodiment the TADs are about 20 to about 24 inches. In a further embodiment the TADs are about 18 to about 22 inches and in still a further embodiment the TADs are about 19 to about 21 inches long.

In an exemplary embodiment the TAD is constructed to be about 18¾ inches long and in another exemplary embodiment the TAD is constructed to be about 19¼ inches long.

The width of the TADs as measured from one outer vertical face of a side bar to the outer vertical face of the other side bar is designed to be as wide or slightly wider than the width of a HTUV tire's driving surface, such that the treads of the tire can fully engage with the cross bars of the TADs. In one embodiment this width of the TADs is about 8 inches.

### TAD Finishing, Anti-Corrosion Protection & Packaging

The TADs of the present disclosure may be finished for consumer appeal and to protect the structural integrity of the TADs from corrosion due to road salt, moisture and other chemical or environmental exposures.

### Anti-Corrosion Coatings

In one embodiment, galvanized steel is used to construct the TADs to protect against corrosion (e.g. A653 galvanized steel).

In addition to, or in the alternative to using a galvanized steel, the TADs may be finished with a suitable coating applied to the surface of the TADs to protect against corrosion. The finishing process applied may be a (dry) powder coating process or a wet painting process as are well known in the art.

A variety of coatings are available to finish the TADs disclosed herein, and the appropriate selection of such finishes is well within the knowledge of one skilled in the art (see for example the listing of metal coating finishes available from the Metal Coatings Corp, Integral Coatings and Systems, and 3M). The selection of an appropriate finishing agent and process will be based on achieving optimal coating adhesion to the metal, exterior durability and the desired degree of anti-corrosion, chemical and physical abrasion resistance. In one embodiment, TAD coatings may be selected from the group consisting of: fluoropolymers (resin/lubricant blends), molybdenum disulfide, epoxy (air dried and thermally cured), ceramic epoxy, acrylic, enamel, polyurethane, and inorganic zinc coatings.

In another embodiment the TADs of the present disclosure are finished using an epoxy coating.

In yet another embodiment the TADS of the present disclosure are finished using a polyester TGIC coating.

In still a further embodiment the TADs of the present disclosure are finished using a polyurethane coating.

In still another embodiment the TADs of the present disclosure are finished using a powder coating process.

### TAD Storage and Packaging

In one embodiment of the invention, a set of two TADs is packaged as a stacked set. As illustrated in FIGS. 1A, 1B and 2, the off-set positioning of traction cleats 11a-11d on and along opposite side bars 3a, 3b allows TADs to be stacked one on top of another by bringing together the undersides of first and second TADs. In this arrangement, the bottom sides 14a, 14b of the side bars 3a, 3b and the bottom side 18 of the end bar 4 of the two TADs meet to form a stacked pair. The second portion 53 of each traction cleat 11a-11d extending beyond the bottom sides 14a, 14b of the side bars 3a, 3b of each TAD 1 can nest adjacent to the vertical, inner sides 15a, 15b of the side bars 3a, 3b of the other TAD 1. In this way, the TADs can be safely stored so that the traction cleats 11a-11d of the first TAD do not protrude beyond the vertical, inner sides 15a, 15b of the second TAD and vice versa, thereby allowing the TADs to be efficiently and safely stored, carried, and unpacked.

In an alternative embodiment four TADs may be stacked by placing a first stacked pair of TADs on top of a second stacked pair of TADs, each pair having been stacked as described in paragraph 53 above.

### Providing Traction Aid to a HTUV

To operate the TADs disclosed herein (as exemplified in FIGS. 1A-1C) the TAD 1 is tilted and the claws 5a, 5b are inserted in between a ground surface and a tire that is not able to gain traction on the ground surface. Before so inserting the TAD, the ground surface may need to be leveled to provide for a substantially flat surface immediately proximal to the front or back end of the tire, depending on whether the HTUV will be moving forward or backward when put into an acceleration mode.

The claws 5a, 5b of the TAD 1 are inserted such that the claw ends 6a, 6b engage the deep tread cavities of the tire. Once the claw ends 6a, 6b have engaged the tire, the HTUV can be put into an acceleration mode and driven over the TAD 1. As the HTUV begins to accelerate the tire engages cross bar 8a and pushes the TAD 1 downward so that the traction cleats 11a, 11c engage with the ground surface. As the HTUV continues to accelerate the tire engages in sequence the remaining cross bars 8b-8d and the traction cleats 11b, 11d also engage the ground surface to fully stabilize the TAD 1 and allow the HTUV to safely drive over and past the TAD 1 without projecting the TAD away from the tire.

A set of four TADs is generally required to provide effective traction aid to HTUVs that are in an immobilized state (stuck) in snow, ice, mud and mixed snow, ice and soft soil conditions, due to the way the power is distributed among the wheels of an axle system of a HTUV. An exemplary HTUV axle system 60 is schematically illustrated in FIG. 4. If one of the wheels 62 on an axle 61 is not engaged with a traction device, more power will be distributed to the free spinning wheel which then reduces the amount of power available to the other wheels to pull the HTUV over the TADs. Depending on the circumstances under which the TADs are needed to provide traction aid to a HTUV, it was observed based on a number of trial runs that the use of only three TADs instead of four can reduce the chances of getting a HTUV double-axle system unstuck. A TAD need only be used with one of the tires of a wheel at the ends of each axle in order to provide traction aid to the wheel.

The disclosures of all patents, patent applications, and publications referenced in this specification are hereby specifically incorporated by reference in their entirety to the same extent as if each such individual patent, patent application, publication and database entry were specifically and individually indicated to be incorporated by reference.

Although the invention has been described with reference to certain specific embodiments, various modifications thereof will be apparent to those skilled in the art without departing from the spirit and scope of the invention. All such modifications as would be apparent to one skilled in the art are intended to be included within the scope of the following claims.

1. A traction aid device comprising:
a U-shaped frame and cross bar system comprising:
a pair of longitudinally extending side bars with first and second ends, disposed substantially parallel to one another;
a plurality of transverse bars disposed between the side bars, including:
an end bar joining the first ends of the side bars; and
three or more cross bars joining the side bars at different points along the length of the side bars, wherein one or more of the three or more cross-bars extends vertically above the top sides of the side bars;
a pair of claws (tongues) converging as extensions of the side bars beyond the transverse bar positioned most distally from the end bar, including claw ends defining the second ends of the side bars and adapted to grip a tire tread;
two or more traction cleats distributed along each side bar and extending vertically below the bottom sides of the side bars, configured to engage a ground surface;
a claw brace joining the pair of claws; and
a brace system comprising:
one or more braces disposed between the plurality of transverse bars to join pairs of transverse bars, wherein one or more of said one or more braces is a linear brace disposed in a substantially perpendicular orientation relative to the pair of transverse bars it joins.

2. The traction aid device according to claim 1, wherein each transverse bar is joined to another transverse bar by at least one brace.

3. The traction aid device according to claim 1, wherein one of the one or more linear braces joins a pair of transverse bars centrally disposed along the length of the side bars.

4. The traction aid device according to claim 1, wherein one or more of the three or more cross bars is flush with the bottom sides of the side bars.

5. The traction aid device according to claim 1, wherein the one or more braces disposed between transverse bars are shorter in height than the transverse bars.

6. The traction aid device according to claim 1, wherein the positioning of traction cleats along the length of one side bar is off set relative to the positioning of traction cleats along the length of the other side bar.

7. The traction aid device according to claim 1, wherein the cross bars extend above the top sides of the side bars and are flush with the bottom sides of the side bars.

8. The traction device according to claim 1, wherein the U-shaped frame is made of a single ¼ inch thick metal strip.

9. The traction aid device according to claim 1, wherein the cross bars are made of ¼ inch thick metal strips.

10. The traction aid device according to claim 1, wherein the traction aid device is made of an iron alloy.

11. The traction aid device according to claim 1, wherein the iron alloy is hot rolled steel.

12. The traction aid device according to claim 1, wherein one or more of the braces disposed between the plurality of transverse bars is a V-brace comprising two V-brace members with first diverging ends and second converging ends.

13. The traction aid device according to claim 12, comprising two V-braces, wherein each V-brace joins a pair of transverse bars disposed along the length of the side bars that are distinct from the pair of transverse bars joined by the one or more linear braces.

14. The traction aid device according to claim 12, wherein one of the V-braces joins the end bar and the cross bar proximal to it and the other V-brace joins the pair of transverse bars disposed proximal to the pair of claws.

15. The traction aid device according to claim 12, wherein the V-brace members converge at the second converging ends to form a V-point.

16. A traction aid device comprising:
a U-shaped frame and cross bar system comprising:
a pair of longitudinally extending side bars with first and second ends, disposed substantially parallel to one another;
a plurality of transverse bars disposed between the side bars, including:
an end bar joining the first ends of the side bars; and
three or more cross bars joining the side bars at different points along the length of the side bars, wherein one or more of the three or more cross-bars extends vertically above the top sides of the side bars;
a pair of claws (tongues) converging as extensions of the side bars beyond the transverse bar positioned most distally from the end bar, including claw ends defining the second ends of the side bars and adapted to grip a tire tread;
two or more traction cleats distributed along each side bar and extending vertically below the bottom sides of the side bars configured to engage a ground surface;
a claw brace joining the pair of claws; and
a brace system comprising:
one or more linear braces, each disposed between and joining a pair of transverse bars, in a substantially perpendicular orientation to said transverse bars; and
one or more V-braces, each including first and second brace members disposed between and joining a pair of transverse bars.

17. The traction aid device according to claim 16, comprising:
five transverse bars;
two linear braces joining three transverse bars centrally disposed along the length of the side bars; and
two V-braces, each joining a pair of transverse bars distinct from the transverse bars joined by the linear brace, one pair of transverse bars being proximal to the first ends of the side bars and the other pair of transverse bars being proximal to the pair of claws.

18. A method of using a traction aid device to provide traction aid to a tire of a heavy transport and utility vehicle (HTUV), wherein the traction aid device comprises:
a U-shaped frame including side bars and an end bar defining the closed end of the frame;
cross bars disposed along the length of and in between the side bars, configured to provide traction aid to a tire of a HTUV;
two claws with claw ends defining the open end of the U-shaped frame and configured to grip the tread cavities of the tire;
traction cleats disposed along the side bars configured to engage a ground surface under and proximal to the tire;
a claw brace joining the claws; and
a plurality of braces disposed in between the end bar of the frame and cross bars to join pairs of bars transverse to the side bars and reinforce the structural integrity and alignment of the traction aid device,
wherein the steps of the method comprise:
inserting the claws of the traction aid device at an angle in between the tire and the ground surface immediately under and proximal to the tire;
engaging the claw ends in the tread cavities of the tire;
putting the HTUV in an acceleration mode; and
driving the HTUV over the traction aid device.

19. The method according to claim 18, wherein the HUTV has a load of about 10,000 lbs or more.

20. The method according to claim 18, wherein the traction aid device comprises:
at least one linear brace joining a pair of cross bars centrally disposed along the length of the side bars; and
at least two V-braces, each joining a pair of bars transverse to the side bars that is distinct from the pair of cross bars joined by the least one linear brace.
